(19) United States
(12) Patent Application Publication
(10) Pub. No.: US 2025/0001318 A1
(43) Pub. Date: Jan. 2, 2025

(54) SAFETY AND COMFORT PULLEY FOR ZIPLINE

(71) Applicant: GULLI CONCEPT, LAROQUE (FR)

(72) Inventor: Grégory GULLI, Escoussans (FR)

(21) Appl. No.: 18/711,207

(22) PCT Filed: Nov. 18, 2022
(86) PCT No.: PCT/EP2022/082479

§ 371 Date: May 17, 2024

(30) Foreign Application Priority Data
Nov. 18, 2021 (FR) 2112209

(51) Int. Cl. A63G 21/22; F16H 55/36

(52) U.S. Cl. CPC A63G 21/22; F16H 55/36

(57) ABSTRACT

A safety and comfort pulley for a zipline, including at least two sheaves, as many shafts as sheaves and a cage. The cage including a first substantially planar flange, a second substantially planar flange, substantially identical to the first flange, and substantially superposed parallel to the first flange and a base connecting the two flanges. The at least two shafts being parallel to each other, coplanar and crossing, substantially perpendicularly, the two flanges and the at least two sheaves being rotatably mounted, each around its associated shaft, between the two flanges, where the pulley further includes a first handle arranged on the outside of the first flange and a second handle arranged on the outside of the second flange.

### CROSS REFERENCE TO RELATED APPLICATIONS

This application is a National Stage of International Application No. PCT/EP2022/082479, having an International Filing Date of 18 Nov. 2022, which designated the United States of America, and which International Application was published under PCT Article 21(2) as WO Publication No. 2023/089128 A1, which claims priority from and the benefit of French Patent Application No. 2112209 filed on 18 Nov. 2021, the disclosures of which are incorporated herein by reference in their entireties.

### BACKGROUND

### Field

The disclosure relates to a safety and comfort pulley for a zipline, of the type used in amusement parks, adventure parks, forest acrobatic parks, or the like. Such a pulley could be arranged on a cable or a rope, tensioned and sloping. This enables a user, suspended under the pulley, to slip along said cable or rope while avoiding accidents to the hands.

### Brief Description of Related Developments

It is known that ziplines require the use of pulleys. Such pulleys typically comprise at least two sheaves, at least as many shafts as sheaves and a cage. The cage comprises two flanges and a base. The flanges are substantially planar, substantially identical, substantially parallel, and are connected together by the base. The cage clasps the sheaves, the plane of rotation of the sheaves substantially coinciding with a mean axis of the flanges. The shafts fix the sheaves, through which they pass at their center throughout the two flanges.

The shafts are parallel to one another and coplanar. Each of the sheaves is rotatably mounted around its associated shaft.

The pulley also comprises, on the side opposite to the base, a ring or a hook enabling suspension of a user, via a harness. The pulley also comprises an opening allowing engaging the pulley on a cable or a rope so as to bring said cable or rope into the grooves arranged at the periphery of the sheaves. When the pulley is in position on a cable or rope, the cage is directed so that the flanges and the planes of rotation of the sheaves are vertical, aligned with the cable or rope, so that the cage is directed so that the base is at the top and the ring or hook at the bottom. Thanks to the rotation of the sheaves on the cable or rope, a user suspended under the pulley can then descend by slipping along the cable or rope.

In fact, the pulleys generally used up to now in zipline systems pose, above all, risks of injury to the hands.

One of the solutions to avoid injuries consists in positioning the hands below the pulley on its own tethers. In this case, there is a risk of automatic rotation on itself and a risk of shocks, in particular at the end of the course, which might cause pain on the back.

In order to reduce the risks, during his/her descent, the user may place his hands under the pulley, at the level of the ring or hook, or at the level of a textile (strap or tether) connecting said ring or hook to the bridge of his/her harness. Such a placement of the hands is advantageous in that it moves the hands of the user away from the cable or rope, movable and therefore potentially vulnerant by friction, and moves the hands of the user away from the cage, and a risk of pinching between a sheave and the cage.

However, such a hand placement does not allow orienting the user relative to the pulley, and therefore to the cable or rope, and a rotation of the user about a vertical suspension axis often occurs.

Another solution is to place one hand on the pulley and the other hand below, on the tethers. In this case, the hand placed on the pulley is close to the cable as well as to the wheels, which could result in injuries to the fingers, in fingernail bending and other risks.

Another possible placement of the hands consists in placing one or two hand(s) on the tether. Such a placement of the hands enables, via a torque exerted by the hand(s) on the cage around a vertical axis, a slight control of the rotation of the user. However, it brings the hand(s) of the user dangerously close to the cable or rope, resulting in a danger of injury by friction, or to the cage, resulting in a danger of pinching between a sheave and the cage.

### SUMMARY

The disclosure suggests modifying a pulley to offer a safe placement of the hands on the pulley, while offering a means for the user to exert a torque on the cage about a vertical axis of suspension.

An object of the present disclosure is the reduction of the aforementioned risks.

For this purpose, an object of the disclosure is a pulley for a zipline, comprising at least two sheaves, as many shafts as sheaves and a cage, the cage comprising a first substantially planar flange, a second substantially planar flange, substantially identical to the first flange, and substantially superposed parallel to the first flange and a base connecting the two flanges, said at least two shafts being parallel to each other, coplanar and crossing, substantially perpendicularly, the two flanges and said at least two sheaves being rotatably mounted, each around its associated shaft, between the two flanges, where the pulley further comprises a first handle arranged on the outside of the first flange and a second handle arranged on the outside of the second flange.

Particular features or aspects, usable alone or in combination, are:
the two handles extend, in use, substantially parallel to the shafts,
the two handles are arranged symmetrically, with respect to a midplane of the two flanges, opposite one another,
an axis common to the two handles is parallel to a plane of the shafts,
the common axis of the handles is arranged, with respect to the plane of the shafts, on the side opposite to the base,
a pulley comprising two shafts, the axis of the handles is arranged in a midplane of the two shafts,
the handles are retractable,
stowage is carried out by folding in the direction of the base,
a handle further comprises a return means, tending to stow the handle,
a handle is covered, at least over its face directed towards the base, with a lining made of a non-slip material, such as a rubber,
a handle further comprises a shaft enabling a rotation of the handle about its axis of extension.

### BRIEF DESCRIPTION OF THE DRAWINGS

The disclosure will be better understood upon reading the following description, made just as example, and with reference to the appended figures wherein:

FIG. 1 shows, in perspective view, a pulley according to the prior art,

FIG. 2 shows, in perspective view, the pulley of FIG. 1 and a hand placement,

FIG. 3 shows, in perspective view, the pulley of FIG. 1 and another hand placement,

FIG. 4 shows, in perspective view, a pulley according to the disclosure, the handles being deployed,

FIG. 5 shows, in perspective view, the pulley of FIG. 4, the handles being folded,

FIG. 6 shows, in perspective view, the pulley of FIG. 4, in use on a cable and the hand placement.

### DETAILED DESCRIPTION

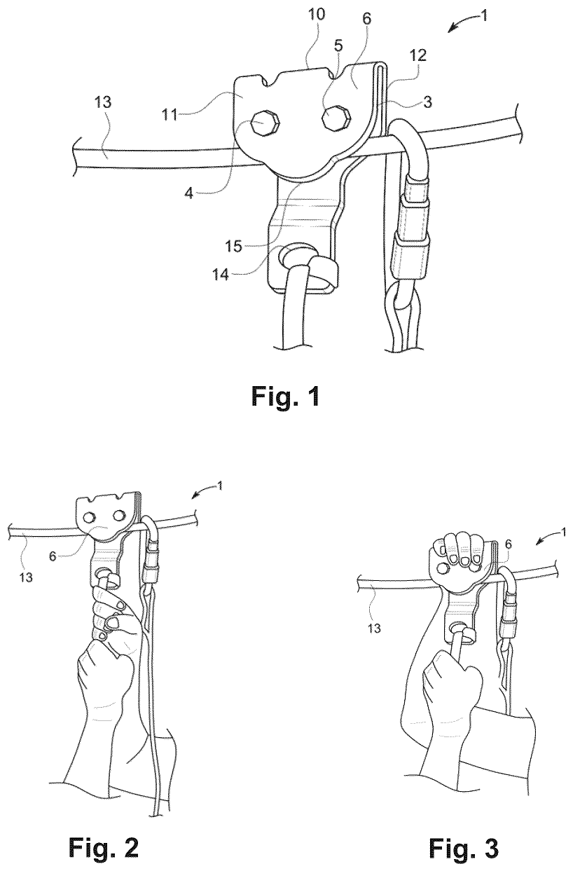

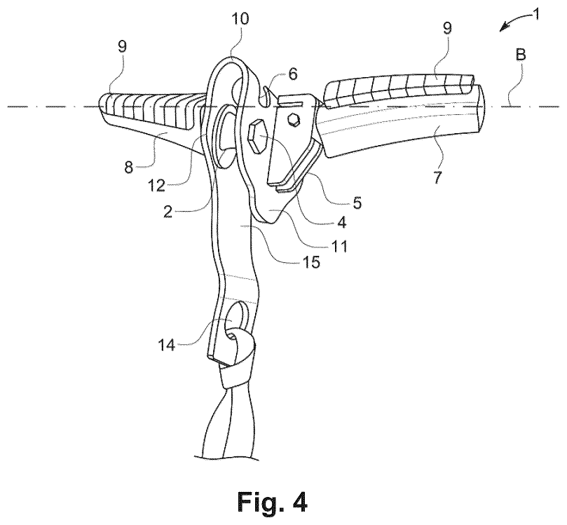

Referring to FIGS. 1 and 4, the disclosure relates to a pulley 1 for a zipline. Conventionally, such a pulley 1 comprises at least two sheaves 2, 3. Each sheave 2, 3 is associated with a shaft 4, 5. Also, a pulley 1 comprises as many shafts 4, 5 as sheaves. A pulley 1 also comprises a cage 6. The cage 6 has a substantially prismatic U-like shape. The cage 6 comprises a first flange 11, a second flange 12 and a base 10. The first flange 11 forms a first branch of the U. The first flange 11 is substantially planar. The second flange 12 is substantially planar, substantially identical to the first flange 11. It is superposed parallel to the first flange 11, the two flanges 11, 12 facing one another. The base 10 rigidly connects the two flanges 11, 12, by spacing them apart, advantageously substantially from the width of the sheaves 2, 3. A cage 6 may be made in one-piece and, as illustrated, be made from a sheet of a metal folded in a U-like fashion so as to form the two flanges 11, 12 and the base 10.

Said at least two shafts 4, 5 are parallel to one another, coplanar in a plane P. They cross the two flanges 11, 12, substantially perpendicularly, to which they are also fastened. Said at least two sheaves 2, 3 are rotatably mounted, conventionally by means of a bearing, such as a ball bearing. Each sheave 2, 3 is mounted around its associated shaft 4, 5. Said at least two sheaves 2, 3 are arranged between the two flanges 11, 12. The plane of rotation of the sheaves 2, 3, passing through the rolling grooves, at the periphery of the sheaves 2, 3 is coincident with a midplane ML of the two flanges 11, 12.

The cage 6 also comprises an opening 15, arranged on the side opposite to the base 10. This opening 15 allows engaging the pulley 1 on a cable or rope so as to press the groove of the sheaves 2, 3 opposite to the base 10 on the cable or rope.

When the pulley 1 is in position on a cable or rope 13, the plane P of the shafts 4, 5 is substantially horizontal, and the plane of rotation of the sheaves 2, 3 is substantially vertical. The sheaves 2, 3 are arranged above the cable or rope 13. The base 10 of the cage 6 is at the top.

The pulley 1 also comprises a ring or hook 14. The ring or hook 14 is arranged in the midplane ML of the flanges 11, 12, so that the suspension point is in the plane of rotation of the sheaves 2, 3. According to the illustrated aspect, the ring or hook 14 is made in one-piece with one of the two flanges 11, 12, that it extends on the side opposite to the base 10. According to another aspect, the ring or hook 14 may be a snap-hook type connector, arranged perpendicularly to the flanges 11, 12.

This ring or hook 14 allows hooking a cord or strap type textile, directly or via a connector of the snap-hook type, to the pulley 1. This textile is conventionally used to connect the user, typically via a harness, to the pulley 1, to which he/she can thus be suspended. When the pulley 1 is in position, on a cable or rope 13, the ring or hook 14 is at the bottom. Thus, the user is suspended under the pulley 1 and under the cable or rope 13.

As illustrated in FIG. 4, according to a feature of the disclosure, the pulley 1 also comprises two handles 7, 8. A first handle 7 is arranged on the outside of the first flange 11. A second handle 8 is arranged on the outside of the second flange 12.

These handles 7, 8, arranged on either side of the cage 6, enable the user to place his/her two hands during a descent. When the pulley 1 is in position on a cable or rope 13, the handles extend on both sides, substantially transversely to the cage 6 and therefore to the cable or rope 13, during use thereof. The hands being positioned around the handles 7, 8, the handles 7, 8 ensure safety of the hands which cannot come into contact with the cable or rope 13 or at the interface between the cable or rope 13 and the sheaves 2, 3.

In addition, by their position and orientation transverse to the cage 6 and to the cable or rope 13, they enable the user to exert a torque about the vertical suspension axis.

According to another feature, the two handles 7, 8 extend substantially parallel to the shafts 4, 5. Thus, the handles 7, 8 extend substantially perpendicularly to the flanges 11, 12 and therefore perpendicularly to the cable or rope 13 in use.

According to another feature, the two handles 7, 8 are arranged symmetrically with respect to one another, with respect to a midplane of the flanges 11, 12, opposite one another. Such an arrangement facilitates the ergonomics of gripping and balance by the user during use.

Advantageously, the handles 7, 8 have a substantially rectilinear extension, normal to the flanges 11, 12. Also, the two handles 7, 8 are arranged on an axis B common to the two handles 7, 8. This axis B is parallel to the plane P of the shafts 4, 5.

As illustrated in FIGS. 4-6, the axis B of the shafts 4, 5 may be arranged above the plane P of the shafts 4, 5.

However, according to another feature, the axis B of the shafts 4, 5 is preferably arranged, with respect to the plane P of the shafts 4, 5, on the side opposite to the base 10. Thus, when the pulley 1 is in position on a cable or rope 13, the axis B of the handles 7, 8 lies below the plane P of the shafts 4, 5. This feature improves the lateral balance of the pulley 1, around the cable or rope 13.

In the case where the pulley 1 comprises exactly two shafts 4, 5, according to another feature, the axis B is advantageously arranged in a midplane M of the two shafts 4, 5. Such an arrangement where the axis B lies at equal distance from the two shafts 4, 5, promotes the longitudinal balance of the pulley 1.

According to a simple aspect, the handles 7, 8 are fixed relative to the cage 6. This aspect is simple and allows obtaining a pulley at low cost. However, when not in use, when the pulley 1 is not engaged on a cable or rope, the pulley 1 is carried by the user or hooked to his/her harness, at the belt. Also, such fixed handles 7, 8, projecting from the cage 6, may be source of interference, discomfort and even become blunt.

Also, according to another feature, the handles 7, 8 are advantageously stowable. Stowage may be obtained according to any aspect. Thus, according to one feature (not illustrated), the handles 7, 8 can be easily dismountable/remountable relative to the cage 6, for example by means of a clipping means.

According to another feature, as illustrated, stowage is carried out by folding the handles 7, 8. Advantageously, this folding is carried out, in the direction of the base 10. Thus, in use, the folding/stowage movement is opposite to the pressing movement when the user is suspended and there is no risk of inadvertent folding.

According to one aspect, folding is performed by means of a joint 16, with an axis substantially parallel to the plane P of the shafts 4, 5, namely with a horizontal axis in use, between a secure attachment, for example by riveting, screwing or welding, of a flange 11, 12 and a movable portion.

When the pulley 1 is in position on a cable 13, folding raises the handles 7, 8 upwards, to place them vertically, substantially perpendicular to the shafts 4, 5. The folded handles 7, 8 are then parallel to the flanges 11, 12.

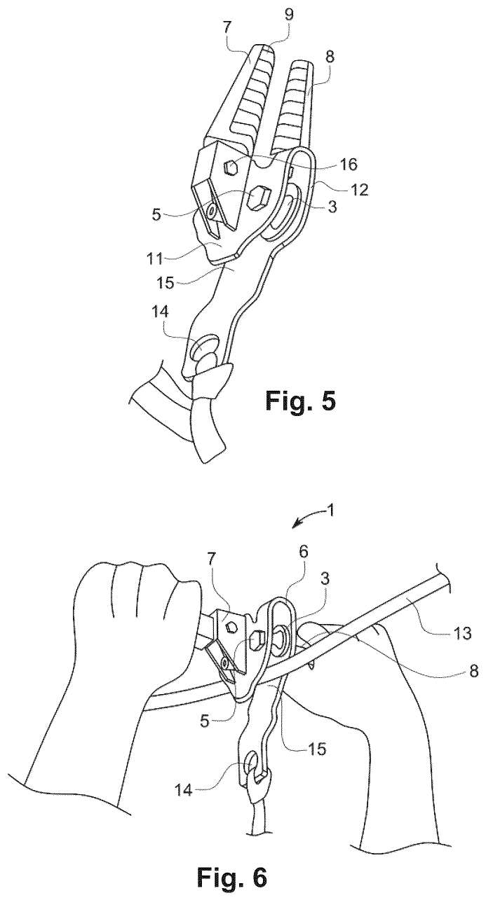

FIG. 4 shows a pulley 1 with the handles 7, 8 unfolded, in the use configuration. FIG. 5 shows the same pulley 1 with the handles folded, corresponding to rather a more compact storage and/or transport configuration.

According to another feature, a handle 7, 8 and advantageously the two handles 7, 8, further comprise a return means, such as an elastic blade or a torsion spring, tending to push the handle 7, 8 into its stowed position. It follows that, by default, the handles 7, 8 are in the stowed position. This facilitates the transport of the pulley 1 when it is not used on a cable or a rope, the stowed handles 7, 8, aligned with the cage 6, with a lesser risk of hooking. On the contrary, when the pulley 1 is used, by gripping the handles 7, 8, the hands of the user oppose the return means and set the handles 7, 8 in the use position, perpendicular to the cage 6. The use of a return means automatically sets the handles 7, 8 in the stowed position. This avoids the user forgetting to stow them, by setting them by default in a more secure position.

The handles could also return automatically to their closed position as soon as they are released, like foldable foot rests for motorcyclists. The handles thus folded, then do not hinder the advance of the motorcycle and allow avoiding the dangers of impaling or impacts for the user on circuit tracks.

According to another feature, a handle 7, 8, or advantageously the two handles 7, 8, is/are advantageously covered, at least over their face directed towards the base 10, with a lining 9. Preferably, this lining 9 is made of a non-slip material, such as a rubber. It may also be made of any textile or plastic material, advantageously flexible, in order to offer more pleasant and/or warmer contact with the hands than metal, while reducing the risk of slip of the hand, relative to the handle 7, 8. When the pulley 1 is in position on a cable 13, the lining 9 is located over the upper face of the handle 7, 8, where the main bearing face of the hands is located.

According to another feature, a handle 7, 8 also comprises a shaft, arranged between the cage 6 and the handle 7, 8, preferably between the joint 16, if the latter is present, and the handle 7, 8. This shaft enables a rotation of the handle 7, 8 about its axis of extension B. Such a rotation improves the ergonomics in that it enables the user to rotate about the axis B according to the phases of use, with, for example, a rearward orientation of the pulley 1 at the beginning, a substantially vertical orientation during the descent and a forward orientation of the pulley 1 at the arrival.

The disclosure has been illustrated and described in detail in the drawings and the previous description. The latter should be considered as illustrative and given as example and not as limiting the disclosure to this sole description. Numerous variants are possible.

### LIST OF THE REFERENCE SIGNS

1: device,
2, 3: sheave,
4, 5: shaft,
6: cage,
7, 8: handle,
9: lining,
10: base,
11, 12: flange,
13: cable or rope,
14: ring or hook,
15: opening,
16: joint.
B: axis of the shafts,
ML: midplane of the flanges/longitudinal,
MT: midplane of the shafts/transverse,
P: plane of the shafts.

What is claimed is:

1. A safety and comfort pulley for a zipline, comprising at least two sheaves, as many shafts as sheaves and a cage, the cage comprising a first substantially planar flange, a second substantially planar flange, substantially identical to the first flange, and substantially superposed parallel to the first flange and a base connecting the two flanges, said at least two shafts being parallel to each other, coplanar and crossing, substantially perpendicularly, the two flanges and said at least two sheaves being rotatably mounted, each around its associated shaft, between the two flanges, characterized in that it further comprises a first handle arranged on the outside of the first flange and a second handle arranged on the outside of the second flange.

2. The pulley according to claim 1, where the two handles extend, in use, substantially parallel to the shafts.

3. The pulley according to claim 1, where the two handles are arranged symmetrically, with respect to a midplane of the two flanges, opposite one another.

4. The pulley according to claim 1, where an axis common to the two handles is parallel to a plane of the shafts.

5. The pulley according to claim 4, where the common axis of the handles is arranged, with respect to a plane of the shafts, on the side opposite to the base.

6. The pulley according to claim 4, comprising two shafts, where the axis of the handles is arranged in a midplane of the two shafts.

7. The pulley according to claim 1, the handles of which automatically return to a closed position as soon as they are released.

8. The pulley according to claim 1, where the handles are stowable.

9. The pulley according to claim 8, where stowage is carried out by folding in the direction of the base.

10. The pulley according to claim 1, where a handle further comprises a return means, tending to stow the handle.

11. The pulley according to claim 1, where a handle is covered, at least over its face directed towards the base, with a lining made of a non-slip material, such as a rubber.

12. The pulley according to claim 1, where a handle further comprises a shaft enabling a rotation of the handle about its axis of extension.
